(19) United States
(12) Patent Application Publication
(10) Pub. No.: US 2018/0049940 A1
(43) Pub. Date: Feb. 22, 2018

(54) Thermal Massage Roller

(71) Applicant: Young Cannon, Pembroke Pines, FL (US)

(72) Inventor: Young Cannon, Pembroke Pines, FL (US)

(21) Appl. No.: 15/240,368

(22) Filed: Aug. 18, 2016

(51) Int. Cl. A61H 15/02

(52) U.S. Cl. CPC A61H 15/02; A61H 2201/0221; A61H 2201/0214; A61H 2201/0207

(57) ABSTRACT

A massage roller and method of use including a thermal pack inside of a rigid protective tube. The tube includes a plurality of apertures to allow the heat or cold of the thermal pack to exit the tube. A thermally passive mesh comfort layer is around the tube. A protective cover is placed over the mesh. The patient is massaged by rolling the heated or cooled massage roller over her body in a pattern.

### BACKGROUND OF THE INVENTION

### 1. Field of the Invention

The present invention relates to personal massage, and more particularly, to a temperature controlled massage aid.

### 2. Description of the Related Art

Several designs for massage aids have been designed in the past. None of them, however, includes a rigid cylinder that contains selectively hot or cold thermal material and a covering that allows efficient thermal transfer between the device and the tissue being massaged.

Applicant believes that the closest reference corresponds to U.S. Pat. No. 9,320,679 issued to Lee. However, it differs from the present invention because the Lee device utilizes a moving roller with a handle to introduce heat during moxibustion therapy. Lee is not adaptable to selectively allow cold delivery and by nature of moxibustion does not use a protective cover. Further, Lee does not disclose the use of hot or cold rechargeable thermal material.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide an extremely durable massage roller that can selectively be heated or cooled in an internal chamber.

It is another object of this invention to provide an effective and compact massage device that is adaptable to different massage objectives and styles.

It is still another object of the present invention to provide a method of introducing heat or massage at any point during a massage therapy session.

Another object of the present invention is to utilize rechargeable thermal retention material to reduce waste, costs and the related environmental impact.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of a thermal massage roller that is partially disassembled.

FIG. 2 shows a perspective view of a thermal massage roller that is assembled.

FIG. 3 shows an exploded perspective view of a thermal massage roller.

FIG. 4 is shows a perspective view of alternate components of a thermal massage roller.

### DETAILED DESCRIPTION OF THE PREFERRED EMBODIMENT

The subject device and method of use is sometimes referred to as the device, the invention, the roller, the massager, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Massage typically involves a therapist or practitioner using their hands to manipulate, soothe and treat a patient. In many situations hand massage is sufficient. However, some advanced techniques benefit from the use of tools or equipment to get a particular result. Other benefits can be realized by the introduction of heat or cold to the tissue treated to improve massage efficacy.

A rigid tube with a soft and clean covering that can easily supply ample heat or cold to the patient during massage therapy has been developed to provide the masseuse and the patient the most effective treatment tools and related methods of use.

Referring now to the drawings, where the present invention is generally referred to with numeral 10, it can be observed that it basically includes a tube 12, a slit 14, a rim 16, a mesh 18, a cover 20, a closure 22, an opening 23, a cap 24 and a thermal pack 26.

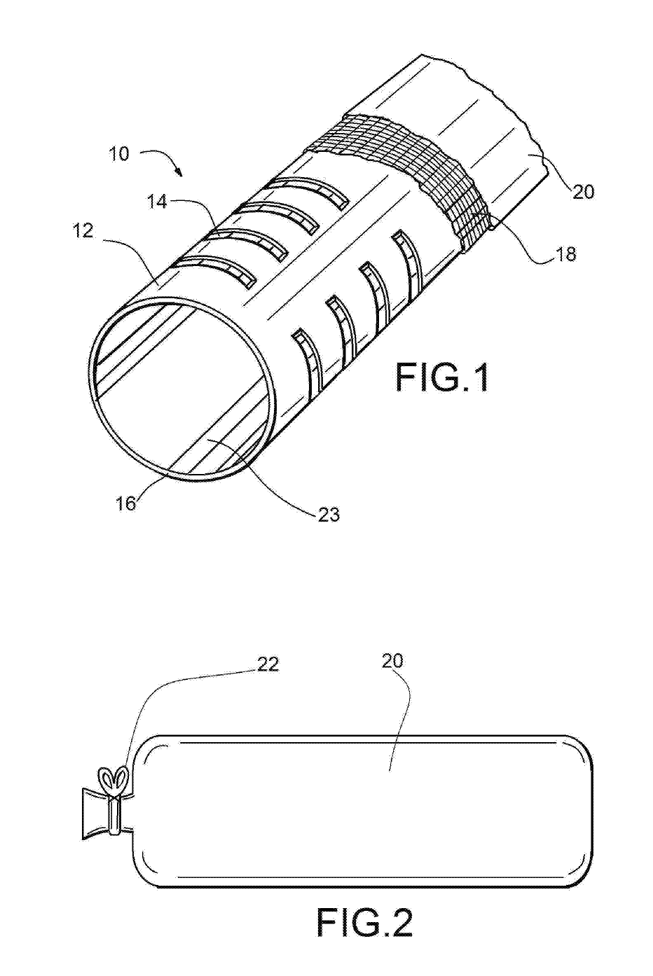

FIG. 1 demonstrates the primary components of a version of the massage roller. In a basic form, the massage roller has a rigid tube 12. The tube 12 has a plurality of slits 14. A thermal pack 26 contained by the tube 12 can allow the transfer of heat or cold from the interior of the tube 12 through the slits 14 so that the patient can experience the heat or cold during a massage.

During assembly of the device prior to use a mesh 18 layer is placed over the tube 12. The mesh 18 generally is adapted to permit transfer of heat or cold provided by the thermal pack 26 from inside the tube 12 to the patient. In an important version of the device the mesh 18 is comprised of a pliable mesh or screen-like material with many spaced openings to allow temperature transfer. A thermally conductive material may also be suitable for use as the mesh 18.

The mesh 18 layer may tend to smooth out the texture of the slits 14 in the tube 12 so that the slits 14 are generally not felt by the practitioner or the patient. Use of the mesh 18 layer will typically result in the tube 12 feeling solid as if the slits 14 were not present.

The mesh 18 layer and the cover 20 are best constructed of a durable and flexible material that is readily washable to maintain the sanitary nature of the device. The mesh 18 and cover 20 may be supplied in duplicate to allow for replacement, also maintaining the sanitary condition of the device.

The cover 20 should allow thermal transfer from inside the tube 12, through all of the other layers, into the patient tissue. This can be achieved by a degree of thermal passivity or conductivity. In one version of the device, the cover 20 is thin, flexible, washable and resists moisture passing through. The thin nature allows thermal transmission even if the material is not highly thermally conductive. The cover 20 optionally having moisture barrier characteristics can, for example, aid in preventing condensation formed inside the tube 12 and the thermal pack 26 from wetting the patient.

FIG. 2 is an example of a massage roller that is ready for use. The cover 20 is secured onto the tube 12 with a closure 22. In this example, the closure 22 is a string tie. Other closure means are readily substituted and could be, for example, a clip, a zipper, buttons, snaps or other similar suitable closure that prevents the cover 20 from unintentionally coming free of the device during normal use.

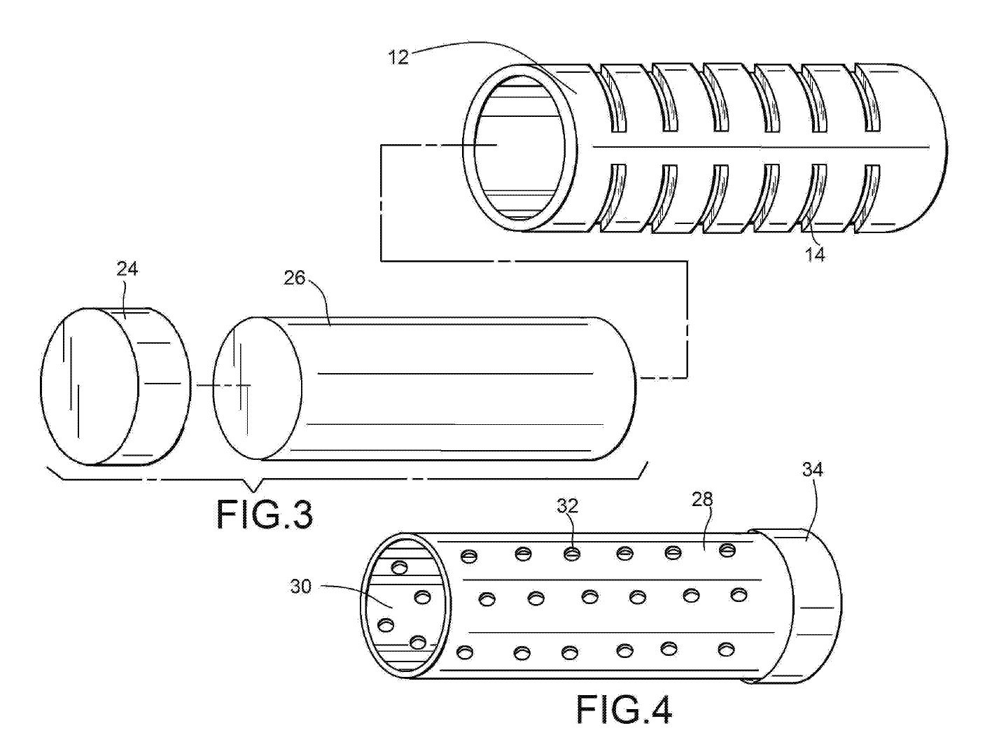

FIG. 3 shows a version of a massage roller removed from the mesh 18 and cover 20 as it might be configured during installation of a thermal pack 26. The thermal pack 26 is dimensioned to fit inside of the tube 12. A cap 24 is optionally provided to affix to the rim 16 and enclose the opening 23. The cap 24 can be friction fit, threaded or otherwise affixed to the rim 16 of the tube 12. If a cap 24 is not used then the cover 20 can actively ensure the thermal pack 26 is retained on the interior of the tube 12 during normal operation of the device.

The thermal pack 26 includes any device or assembly that can retain heat or cold for dispensation through the layers of the device to be felt on the patient's body. The thermal pack 26 can be a reusable pack or can be single use. For a cooling thermal pack 26 a means as simple as a bag with ice would be effective. A reusable hot-or-cold pack would also be an effective choice because the thermal pack could be easily chilled or heated prior to insertion into the tube 12.

Chemical based thermal pack 26 could be utilized effectively. For example, an ammonium nitrate or urea sac can be broken inside a water sac for rapid onset cooling. This type of cool pack is commonly used in sports medicine and first aid as a one use cooling bag. This bag can be rolled to fit inside the tube 12.

Other cooling devices can be adapted to fit inside the tube 12 that are similar to a re-useable freezer pack that is used in many portable coolers. This style of device is frequently blue in color and is comprised of a plastic shaped device containing compounds such as diethylene glycol or ethylene glycol. Other chemistries of thermal packs 26 could be utilized if they are safe and fit inside the tube 12.

The thermal pack 26 may also provide heat. A thermal pack 26 may be made of a substance that retains heat that can be transferred to the patient. A microwaved bag of rice, a boiled bag of water, heated metal, glass or other solids may each be effective. Chemical thermal packs may also be effective. For example, iron powder and salts or catalysts in a sealed package with liquid can produce heat. Sodium acetate in solution triggered by flexing a metal disk can produce heat. Alternatively calcium chloride solutions can safely work. Electrically heated assemblies could also be effective in producing a safe and steady flow of heat to the patient during a massage.

Looking now at FIG. 4 where some alternate features are exemplified and include, among other things, a tube 28, an opening 30, apertures 32 and a cap 32. The apertures 34 in the tube 28 are used as an alternative to the slits 14 in other versions to facilitate thermal transfer from inside the tube 28 to the patient.

Similar to other versions of the device, a cap 34 (or cap 24) on one or both ends may be provided to secure a thermal pack 26 inside the tube 28. If a cap 34 is not used then the cover 20 can retain the thermal pack 26 inside the tube 28.

The apertures 32 in FIG. 4 are shown to be cylindrical bores but could be any shape or geometry to allow the heat or cold contained inside the tube 28 to transfer out so that the massaged receives the benefit of the heat or cold. For example, slots oriented in several directions, rectangular apertures or other shapes may be effective at containing the thermal pack 26 and yet allowing the heat or cold to pass through the tube 28 into the patient.

During typical use a massage therapist would remove the cap 24 to insert an activated thermal pack 26. Depending on the application, the thermal pack 26 could provide heat or cold. The cap 24 is replaced to enclose the end of the tube 12 and retain the thermal pack 26. The mesh layer 18 is placed over the tube 12 to provide a cushion to the patient so the slits 14 are not felt yet to allow thermal passivity from the thermal pack 26 to the patient. An optional soft protective cover 20 is placed over the balance of the components to ensure that the patient's body only contacts the cover 20.

The therapist then can use the massage roller to manually manipulate the patient by pressing and rolling the massage roller over the patient's body. A therapist might roll the heated or cooled tube over tender muscles in similar fashion that a baker might use a rolling pin on dough. The massaging action combined with the thermal component provides massage and relief to the patient.

A patient may also be able to use the massage roller without a second person therapist. A person may be able to roll the massage roller under their feet, on their own arms, legs, neck or other location on the body in need of thermal massage manipulation.

A successful version of the inventive concept can be fairly described as a massage roller comprised of a tube, a mesh, a cover and a thermal pack. The tube has rigid exterior and an open interior, essentially a hollow cylinder. The rigid exterior has a plurality of apertures completely penetrating the rigid exterior. The thermal pack provides either a heat or a cold. The thermal pack contains a thermally productive material, possibly similar to the reusable blue packs used in many coolers. The open interior fits the thermal pack entirely within the tube to protect it. The thermal pack is removable from the open interior so it can be replaced or serviced. The tube prevents any pressure applied to the thermal pack avoiding a rupture. A mesh encloses the rigid exterior for padding yet allowing thermal conductivity. The mesh allows the heat or cold provided by the thermal pack to transfer into the cover. A cover covers the mesh. The cover allows the heat or cold provided by the thermal pack to transfer out of the massage roller.

The inventive concept also includes a method of thermal massage comprised of rolling a massage roller over a patient in a predetermined pattern. The massage roller is comprised of a tube, a mesh, a cover and a thermal pack. The tube has rigid exterior and an open interior. The rigid exterior has a plurality of apertures completely penetrating the rigid exterior. The thermal pack provides either a heat or a cold. The open interior fits the thermal pack entirely within the tube. The tube prevents any pressure applied to the thermal pack. A mesh encloses the rigid exterior. The mesh allows the heat or cold provided by the thermal pack to transfer into the cover. A cover covers the mesh. The cover allows the heat or cold provided by the thermal pack to transfer out of the massage roller into the patient.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A massage roller comprised of a tube, a mesh, a cover and a thermal pack;
the tube has rigid exterior and an open interior;
the rigid exterior has a plurality of apertures completely penetrating the rigid exterior;
the thermal pack provides either a heat or a cold;
the open interior fits the thermal pack entirely within the tube;
the thermal pack is removable from the open interior;
the tube prevents any pressure applied to the thermal pack;
a mesh encloses the rigid exterior;
the mesh allows the heat or cold provided by the thermal pack to transfer into the cover;
a cover covers the mesh;
the cover allows the heat or cold provided by the thermal pack to transfer out of the massage roller.

2. A method of thermal massage comprised of rolling a massage roller over a patient in a predetermined pattern;
the massage roller is comprised of a tube, a mesh, a cover and a thermal pack;
the tube has rigid exterior and an open interior;
the rigid exterior has a plurality of apertures completely penetrating the rigid exterior;
the thermal pack provides either a heat or a cold;
the open interior fits the thermal pack entirely within the tube;
the tube prevents any pressure applied to the thermal pack;
a mesh encloses the rigid exterior;
the mesh allows the heat or cold provided by the thermal pack to transfer into the cover;
a cover covers the mesh;
the cover allows the heat or cold provided by the thermal pack to transfer out of the massage roller into the patient.
